(19) United States
(12) Patent Application Publication
(10) Pub. No.: US 2008/0111468 A1
(43) Pub. Date: May 15, 2008

(54) Light emission device and display device using the light emission device as backlight unit

(76) Inventor: Jin-Ho Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/732,609

(22) Filed: Apr. 3, 2007

(30) Foreign Application Priority Data
Nov. 15, 2006 (KR) 10-2006-0112922

(51) Int. Cl. H01J 63/04

(52) U.S. Cl. 313/496

(57) ABSTRACT

A light emission device is disclosed. In one embodiment, the light emission device includes i) first and second substrates facing each other, each of the first and second substrates having an active area and an inactive area surrounding the active area, ii) an electron emission unit provided on the active area of the first substrate and having a plurality of pixels independently controlled in their electron emission, and iii) a light emission unit provided on the active area of the second substrate. The light emission unit may include i) a plurality of phosphor layers formed on the second substrate and spaced apart from each other, ii) a conductive layer disposed between the phosphor layer, and iii) an anode electrode formed on surfaces of the phosphor and conductive layers. The light emission unit may satisfy the following relationship: about 0.89≦A₂/A₁≦about 0.98. A₁ is an area of the active area of the second substrate and A₂ is an area of the phosphor layers.

### CROSS-REFERENCE TO RELATED APPLICATION

This application claims priority to Korean patent application No. 10-2006-112922 filed in the Korean Intellectual Property Office on Nov. 15, 2006, and all the benefits accruing therefrom under 35 U.S.C. §119, the contents of which are herein incorporated by reference in their entirety.

### BACKGROUND OF THE INVENTION

1. Field of the Invention

The present invention relates a light emission device which can be used as a light source for a display device.

2. Description of the Related Art

A liquid crystal display (LCD) that is one of a variety of non-self emissive display devices displays an image by varying a light transmission amount at each pixel using a dielectric anisotropy of liquid crystal that varies in a twisting angle according to a voltage applied. The LCD is lightweight and requires less space and less power consumption compared to a conventional cathode ray tube.

The LCD includes a liquid crystal (LC) panel assembly and a backlight unit for emitting light toward the LC panel assembly. The LC panel assembly receives light emitted from the backlight unit and allows the light to be transmitted or blocked by a liquid crystal layer.

The backlight unit is classified according to a light source into different types, one of which is a cold cathode fluorescent lamp (CCFL). The CCFL is a linear light source that can uniformly emit the light to the LC panel assembly through optical members such as a diffusion sheet, a diffuser plate, and/or a prism sheet.

However, since the CCFL emits the light through the optical members, there may be a light loss. In the CCFL type LCD, only 3-5% of light generated from the CCFL is transmitted through the LC panel assembly. Furthermore, since the CCFL has relatively higher power consumption, the overall power consumption of the LCD employing the CCFL increases. In addition, since the CCFL is difficult to be large-sized due to its structure limitation, it is hard to be applied to a large-sized LCD over 30-inch.

A backlight unit employing light emission diodes (LEDs) is also well known. The LEDs are point light sources that are combined with an optical members such as a reflection sheet, a light guiding plate, a diffusion sheet, a diffuser plate, a prism sheet, and/or the like, thereby forming the backlight unit. The LED type backlight unit has fast response time and good color reproduction. However, the LED is costly and increases an overall thickness of the LCD.

All of the above-described conventional backlight units maintain a uniform brightness all over the light emission area when the LCD operates. Therefore, it is difficult to improve the display quality to a sufficient level.

For example, when the LC panel assembly intendeds to display an image having a bright portion and a dark portion in response to an image signal, it will be possible to realize an image having a more improved dynamic contrast if the backlight unit can emit lights having different intensities to pixels of the LC panel assembly displaying the dark and bright portions.

However, the conventional backlight units cannot achieve the above function and thus there is a limitation in improving the dynamic contrast of the image displayed by the LCD.

### SUMMARY OF CERTAIN INVENTIVE ASPECTS

One aspect of the present invention provides a light emission device that can improve light emission efficiency of a phosphor layer and prevent arc discharge by preventing the phosphor layer from being charged with electricity and a display device using the light emission device as a backlight unit.

Another aspect of the present invention provides a light emission device that can divide a light emission area into a plurality of regions and independently controlling light intensities of the regions and a display device that can enhance the dynamic contrast of the screen by using the light emission device as a backlight unit.

Another aspect of the present invention provides a light emission device including i) first and second substrates facing each other, each of the first and second substrates having an active area and an inactive area surrounding the active area, ii) an electron emission unit provided on the active area of the first substrate and having a plurality of pixels independently controlled in their electron emission, and iii) a light emission unit provided on the active area of the second substrate. In one embodiment, the light emission unit includes i) a plurality of phosphor layers formed on the second substrate and spaced apart from each other, ii) a conductive layer disposed between the phosphor layer, and iii) an anode electrode formed on surfaces of the phosphor and conductive layers. The light emission unit may satisfy the following relationship: A₂/A₁≧about 0.80. A₁ is an area of the active area of the second substrate and A₂ is an area of the phosphor layers.

The area (A₁) and the area (A₂) may satisfy the following relationship: A₂/A₁≦about 0.98.

The phosphor layers may be white phosphor layers emitting white light and one phosphor layer corresponds to at least one pixel region.

The conductive layer may be formed of a conductive carbon-based material or a metal selected from the group consisting of Al, Mo, Cr, and an alloy thereof.

The active areas may be configured to emit light and light may be not emitted from the inactive areas.

Another aspect of the present invention provides a light emission device including i) first and second substrates facing each other, ii) each of the first and second substrates having an active area and an inactive area surrounding the active area, iii) an electron emission unit provided on the active area of the first substrate and having a plurality of pixels independently controlled in their electron emission and iv) a light emission unit provided on the active area of the second substrate. In one embodiment, the light emission unit includes i) a plurality of phosphor layers formed on the second substrate and spaced apart from each other, ii) a conductive layer disposed between the phosphor layer, and iii) an anode electrode formed on surfaces of the phosphor and conductive layers. The light emission unit may satisfy the following relationship: about 0.02≦A₃/A₁≦about 0.20. A₁ is the area of the active area of the second substrate and A₃ is an area of the conductive layer.

The area (A₁) of the active area of the second substrate and the entire area (A₂) of the phosphor layers may satisfy the following relationship: A₂/A₁≧about 0.80.

Another aspect of the present invention provides a display device including i) a display panel for displaying an image, and ii) a light emission device for emitting light toward the display panel. The light emission device comprises i) first and second substrates facing each other, each of the first and second substrates having an active area and an inactive area surrounding the active area, ii) an electron emission unit provided on the active area of the first substrate, and iii) a light emission unit provided on the active area of the second substrate. In one embodiment, the light emission unit includes i) a plurality of phosphor layers formed on the second substrate and spaced apart from each other, ii) a conductive layer disposed between the phosphor layer, and iii) an anode electrode formed on surfaces of the phosphor and conductive layers. The light emission unit may satisfy the following relationship: A₂/A₁≧about 0.80. The A₁ is an area of the active area of the second substrate and A₂ is an area of the phosphor layers.

The electron emission unit may include i) a plurality of first electrodes formed on the first substrate and extending in a first direction, ii) a plurality of second electrodes formed on the first substrate and extending in a second direction crossing the first direction, the second electrodes being insulated from the first electrode, and iii) a plurality of electron emission regions electrically connected to the first electrodes or the second electrodes.

Another aspect of the present invention provides a display device including i) a display panel for displaying an image, and ii) a light emission device for emitting light toward the display panel. The light emission device may comprise i) first and second substrates facing each other, each of the first and second substrates having an active area and an inactive area surrounding the active area, ii) an electron emission unit provided on the active area of the first substrate, and iii) a light emission unit provided on the active area of the second substrate. In one embodiment, the light emission unit includes i) a plurality of phosphor layers formed on the second substrate and spaced apart from each other, ii) a conductive layer disposed between the phosphor layer, and iii) an anode electrode formed on surfaces of the phosphor and conductive layers. The light emission unit satisfies the following relationship: A₃/A₁≧about 0.02. A₁ is the area of the active area of the second substrate and A₃ is an area of the conductive layer.

The phosphor layer may include a plurality of sections spaced apart from each other. Each section may correspond to at least two pixels of the light emission device.

The conductive layer may be configured to transfer electrons remaining in the phosphor layer to the inactive area. The conductive layer may be configured to absorb at least a portion of light reflected from or transmitted through the display panel.

The area (A₁) of the active area of the second substrate and the area (A₃) of the conductive layer may satisfy the following relationship: A₃/A₁≦about 0.20.

### BRIEF DESCRIPTION OF THE DRAWINGS

FIG. 1 is a sectional view of a light emission device according to an embodiment of the present invention.

FIG. 2 is a partial exploded perspective view of an active region of the light emission device of FIG. 1.

FIG. 3 is a partial top view of a light emission assembly of the light emission device of FIG. 1.

FIG. 4 is an exploded perspective view of a display device according to an embodiment of the present invention.

### DETAILED DESCRIPTION OF CERTAIN INVENTIVE EMBODIMENTS

Embodiments of the present invention will now be described more fully with reference to the accompanying drawings, in which exemplary embodiments of the invention are shown.

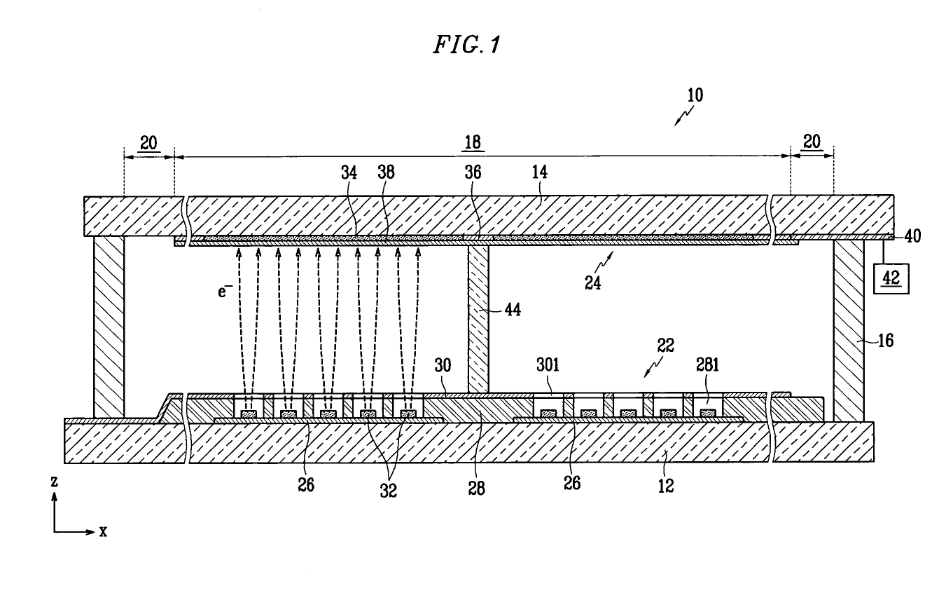

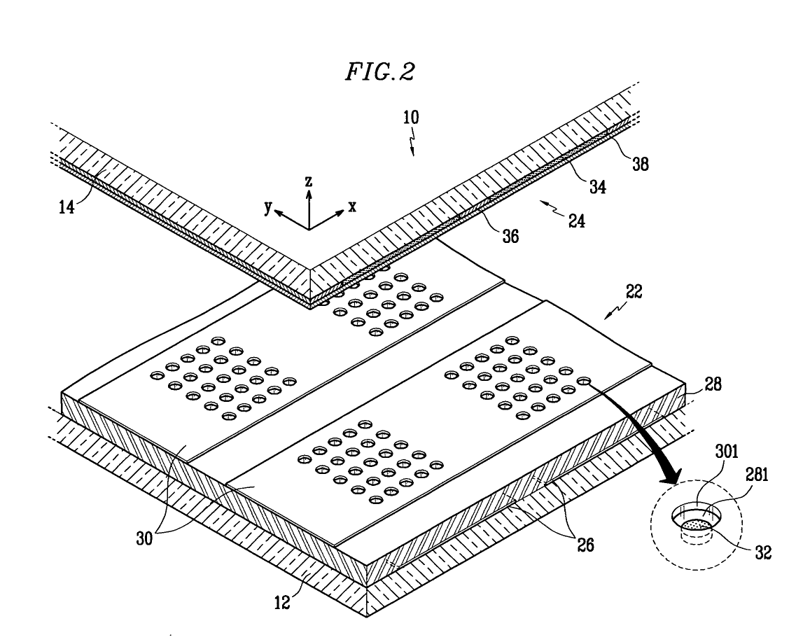

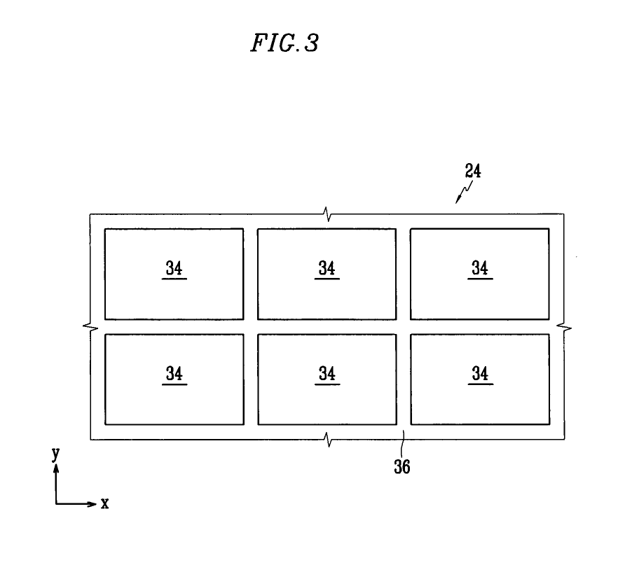

FIG. 1 is a sectional view of a light emission device 10 according to an embodiment of the present invention, FIG. 2 is a partial exploded perspective view of an active region of the light emission device 10 of FIG. 1, and FIG. 3 is a partial top view of a light emission assembly of the light emission device 10 of FIG. 1.

Referring to FIGS. 1 to 3, the light emission device 10 includes first and second substrates 12 and 14 facing each other at a predetermined interval. A sealing member 16 is provided at the peripheries of the first and second substrates 12 and 14 to seal them together and thus form a sealed vessel. The interior of the sealed vessel is kept to a degree of vacuum of about 10⁻⁶ Torr.

Each of the first and second substrates 12 and 14 has an active area 18 configured to emit visible light and an inactive area 20 surrounding the active area 18 within an area surrounded by the seal member 16. An electron emission unit 22 emitting electrons using electric field is provided on the active area 18 of the first substrate 12 and a light emission unit 24 for emitting the visible light using the electrons is provided on the active area 18 of the second substrate 14.

The electron emission unit 22 includes first electrodes 26 arranged in a stripe pattern running in a direction of the first substrate 12, second electrodes 30 arranged in a stripe pattern running in a direction crossing the first electrodes 26, an insulating layer 28 interposed between the first electrodes 26 and the second electrodes 30, and electron emission regions 32 electrically connected to one of the first and second electrodes 26 and 30.

When the electron emission regions 32 are formed on the first electrodes 26, the first electrodes 26 function as cathode electrodes applying a current to the electron emission regions 32 and the second electrodes 30 function as gate electrodes inducing the electron emission by forming the electric field around the electrode emission regions 32 according to a voltage difference between the cathode and gate electrodes. On the contrary, when the electron emission regions 32 are formed on the second electrodes 30, the second electrodes 30 function as the cathode electrodes and the first electrodes 26 function as the gate electrodes.

In FIG. 1, the electron emission regions 32 are formed on the first electrodes 26. The first electrodes 26 may be arranged along columns (i.e., a y-axis direction) and the second electrodes 30 may be arranged along rows (i.e., an x-axis direction). In this case, the second electrodes 30 may serve as scan electrodes by receiving a scan driving voltage and the first electrodes 26 may serve as data electrodes by receiving a data driving voltage.

The electron emission regions 32 are formed on the first electrodes 26 at crossed regions of the first and second electrodes 26 and 30. Openings 301 and 281 corresponding to the respective electron emission regions 32 are formed through the insulating layer 28 and the second electrodes 30 to expose the electron emission regions 32.

The electron emission regions 32 are formed of a material emitting electrons when an electric field is applied thereto under a vacuum atmosphere, such as a carbonaceous material or a nanometer-sized material. The electron emission regions 32 can be formed of carbon nanotubes, graphite, graphite nanofibers, diamonds, diamond-like carbon, C₆₀, silicon nanowires or a combination thereof. The electron emission regions 32 can be formed through a screen-printing process, a direct growth, a chemical vapor deposition, or a sputtering process.

Alternatively, the electron emission regions can be formed in a tip structure formed of a Mo-based or Si-based material.

One crossed region (one of four electron emission groups shown in FIG. 2) of the first and second electrodes 26 and 30 may correspond to one pixel region of the light emission device 10. Alternatively, two or more crossed regions of the first and second electrodes 26 and 30 may correspond to one pixel region of the light emission device 10. In this case, two or more first electrodes 26 and/or two or more second electrodes 30 that are placed in one pixel region are electrically connected to each other to receive a common driving voltage.

The light emission unit 24 includes a plurality of phosphor layers 34 formed on the second substrate 14 and spaced apart from each other, a conductive layer 36 formed between the phosphor layers 34, an anode electrode 38 formed on the phosphor layers 34 and the conductive layer 36.

One or more phosphor layers 34 may correspond to one pixel region. Alternatively, one phosphor layer 34 may correspond to two or more pixel regions. In all of these cases, the phosphor layer 34 may be formed in a rectangular shape as shown in FIG. 3.

The phosphor layer 34 may be a white phosphor layer or a combination of red, green and blue phosphor layers.

The white phosphor layer may be formed on an entire active area of the first substrate 12 or divided into a plurality of sections corresponding to the respective pixels. The red, green and blue phosphor layers are formed corresponding to one pixel region. In FIG. 3, a case where one white phosphor layer is formed on each pixel region is exampled.

The conductive layer 36 is formed of a material having a relatively high electrical conductivity. That is, the conductive layer 36 is formed of a conductive carbon-based material such as graphite or a material selected from the group consisting of Al, Mo, Cr, and an alloy thereof. The conductive layer 36 may exhibit black or have a light reflection property according to their material. The conductive layer 36 is arranged in a lattice pattern in response to the arrangement of the phosphor layers 34.

The conductive layer 36 functions as a conductive path along which the electrons colliding with the phosphor layers 34 are discharged to an external side, thereby preventing the surfaces of the phosphor layers 34 from being charged with electricity. To achieve this, the conductive layer 36 is electrically connected to an anode lead 40 and the anode electrode 38 and the anode lead 40 extends out of the vacuum vessel and is coupled to an anode voltage applying portion 42 applying the anode voltage to the anode electrode 38 (see FIG. 1).

In a conventional electron emission device, the phosphor layer is generally disposed on the entire active area of the front substrate to maximize a light emission area of the phosphor layer. In this case, a conductive path is not formed. Therefore, the electrons colliding with the phosphor layer are accumulated on a surface of the phosphor layer and thus the phosphor layer is negatively charged. The negatively charged phosphor layer repulses the electrons emitted from an electron emission region to deteriorate the overall light emission efficiency. In addition, the charged phosphor layer may cause an arc discharge when a high voltage is applied to the anode electrode.

The anode electrode 38 can be formed of, for example, a metallic material such as aluminum covering the phosphor layers 34 and the conductive layer 36. The anode electrode 38 receives a high voltage for accelerating the electron beams, and reflects the visible light rays radiated from the phosphor layers 34 to the first substrate 12, toward the second substrate 14. As a result, the luminance of the electron emission device 10 is enhanced.

A fine gap may be formed between the anode electrode 38 and the phosphor and conductive layers 34 and 36 as follows. First, an interlayer (not shown) formed of a polymer material that can be decomposed at a high temperature is formed on the phosphor and conductive layers 34 and 36. Next, the anode electrode 38 is formed by depositing metal on the interlayer. Then, the interlayer is removed through a firing process, thereby forming the fine gap.

Spacers 44 (see FIG. 1) are located between the first and second substrates 12 and 14 for uniformly maintaining a gap therebetween against the outer force. The spacers 44 are arranged corresponding to the conductive layer 36 not to interfere with the light emission from the phosphor layers 34.

The above-described light emission device 10 is driven by applying the data driving voltage to the first electrodes 26, applying the scan driving voltage to the second electrodes 30, and applying thousands volt of a positive DC voltage to the anode electrode 38.

Then, an electric field is formed around the electron emission regions 32 at pixel regions where a voltage difference between the first and second electrodes 26 and 30 is higher than a threshold value, thereby emitting electrons from the electron emission regions 32. The emitted electrons are accelerated by the high voltage applied to the anode electrode 38 to collide with specific portions of the phosphor layers 34, thereby exciting the phosphor layers 34. A light emission intensity of the phosphor layer(s) 34 at each pixel corresponds to an electron emission amount of the corresponding pixel.

In one embodiment, the light emission unit 24 of the light emission device 10 satisfies the following Equation 1.

A₂/A₁≧about 0.80 [Equation 1]

where, A₁ is an area of the active area 18 of the second substrate 14 and A₂ is an area of the phosphor layers 34.

In one embodiment, the overall area of the phosphor layers 34 is about 80-98% of the active area 18 of the second substrate 14. In another embodiment, the light emission unit 24 satisfies: about 0.80≦A₂/A₁≦about 0.98. In another embodiment, A₂/A₁ may be greater than about 0.98.

In another embodiment, the light emission unit 24 satisfies the following Equation 2.

A₃/A₁≧about 0.02 [Equation 2]

where, A₁ is the area of the active area 18 of the second substrate 14 and A₃ is an overall area of the conductive layer 36. In another embodiment, the light emission unit 24 satisfies the following: about 0.02≦A₃/A₁≦about 0.20.

Equation 2 shows that the overall area of the conductive layer 36 is about 2-20% of the active area 18 of the second substrate 14.

As an area taken by the phosphor layers 34 at the active area 18 of the second substrate 14 is reduced, the luminance of the light emission surface is reduced. Therefore, the A₂/A₁ is equal to or greater than about 0.80 to realize the sufficient luminance.

In addition, when the A₂/A₁ is less than about 0.80, the area taken by the conductive layer 36 at the active area 18 increases excessively. In this case, the conductive layer 36 may be seen from the outside of the light emission device 10 and the luminance uniformity of the light emission surface is deteriorated. Therefore, a diffuser plate is generally installed in front of the light emission device 10 to increase the luminance uniformity by scattering the light emitted from the phosphor layers 34. When the diffuser plate is installed, a gap between the second substrate 14 and the diffuser plate must be equal to or greater than 10 mm. This increases the thickness of a display device. In one embodiment, the light emission device does not require a diffuser plate. When A₂/A₁ is in the range of about 0.80 to about 0.98, it is possible to reduce manufacturing costs. Furthermore, the conductive layer 36 can be efficiently formed between phosphor layers in the above range.

Meanwhile, when the area taken by the conductive layer 36 is less than 2% of the active area 18 of the second substrate 14, a function of the conductive layer 36, which discharges electric charges accumulated on the phosphor layers 34 to the exterior, is deteriorated. Therefore, even when the conductive layer 36 is formed, the electric charging suppressing cannot be sufficiently obtained. Consequently, due to the electric charges accumulated on the phosphor layers 34, the acceleration of the electron beams directing toward the phosphor layers 34 is reduced to deteriorate the luminance of the light emission surface.

In one embodiment, since the phosphor layers 34 and the conductive layer 36 are formed to satisfy the above-described condition, the accumulation of the electric charges on the phosphor layers 34 can be effectively suppressed to enhance the luminance of the light emission surface and maintain the high-level of the luminance uniformity of the light emission surface.

In this embodiment, the gap between the first and second substrates 12 and 14 may be, for example, about 5 to about 20 mm that is greater than that of a conventional electron emission device. The anode electrode 38 may receive a high voltage, for example, greater than about 10 kV, or about 10-15 kV, through the anode voltage applying portion 42. Accordingly, the light emission device 10 realizes a luminance above 10,000 cd/m² at a central portion of the active area 18.

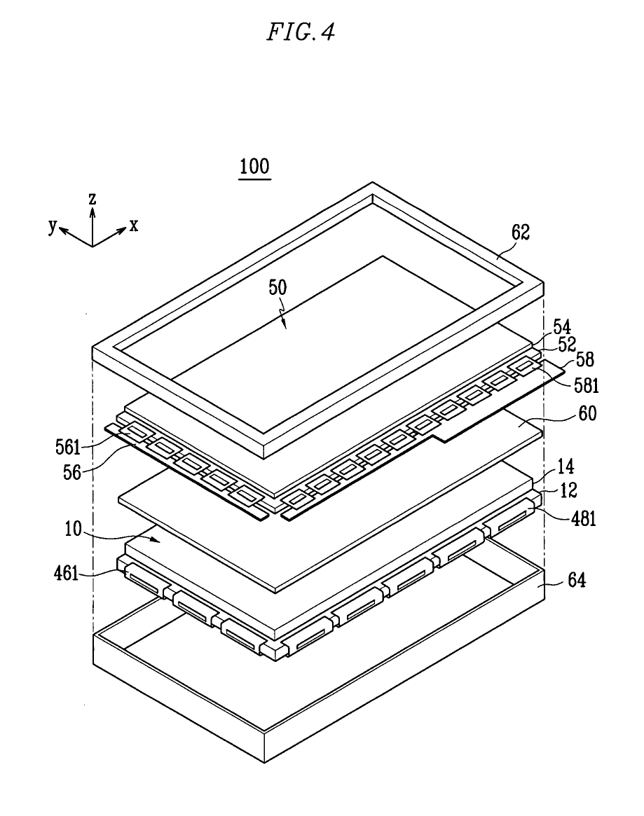

FIG. 4 is an exploded perspective view of a display device employing the above-described light emission device as a backlight unit according to an embodiment of the present invention. The display device of FIG. 4 is exemplary only, not limiting the present invention.

Referring to FIG. 4, a display device 100 of this embodiment includes a light emission device 10 and a display panel 50 disposed in front of the light emission device 10. A diffuser 60 for uniformly diffusing the light emitted from the light emission device 10 toward the display panel 50 may be disposed between the display panel 50 and the light emission device 10. The diffuser 60 may be spaced apart from the light emission device 10 by a predetermined distance. A top chassis 62 is disposed in front of the display panel 50 and a bottom chassis 64 is disposed in rear of the light emission device 10.

The display panel 50 may be a liquid crystal display panel or other non-self emissive display panels. In the following description, the liquid crystal display panel is exampled.

The display panel 50 includes a thin film transistor (TFT) substrate 52 comprised of a plurality of TFTs, a color filter substrate 54 disposed on the TFT substrate 52, and a liquid crystal layer (not shown) disposed between the TFT substrate 52 and the color filter substrate 54. Polarizer plates (not shown) are attached on a top surface of the color filter substrate 54 and a bottom surface of the TFT substrate 52 to polarize the light passing through the display panel 50.

The TFT substrate 52 is a glass substrate on which the TFTs are arranged in a matrix pattern. A data line is connected to a source terminal of the TFT and a gate line is connected to a gate terminal of the TFT. In addition, a pixel electrode formed of a transparent conductive layer is connected to a drain terminal of the TFT.

When electric signals are inputted from printed circuit boards 56 and 58 to the respective gate and data lines, electric signals are inputted to the gate and source terminals of the TFT. Then, the TFT turns on or off according to the electric signals inputted thereto, and output an electric signal required for driving the pixel electrode to the drain terminal.

RGB color filters are formed on the color filter substrate 54 so as to emit predetermined colors as the light passes through the color filter substrate 54. A common electrode (not shown) formed of a transparent conductive layer is deposited on an entire surface of the color filter substrate 54.

When electric power is applied to the gate and source terminals of the TFTs to turn on the TFTs, an electric field is formed between the pixel electrode and the common electrode. By the electric field, the orientation angle of liquid crystal molecules of the liquid crystal layer varies and thus the light transmissivity of each pixel varies according to the varied orientation angle of the liquid crystal molecules.

The printed circuit boards 56 and 58 of the display panel 50 are connected to drive IC packages 561 and 581, respectively. In order to drive the display panel 50, the gate printed circuit board 56 transmits a gate driving signal and the data printed circuit board 58 transmits a data driving signal.

The number of pixels of the light emission device 10 is less than that of the display panel 50 so that one pixel of the light emission device 10 corresponds to two or more pixels of the display panel 50. Each pixel of the light emission device 10 emits light in response to the highest gray value among the corresponding pixels of the display panel 50. The light emission device 10 can represent 2˜8 bits gray value at each pixel.

For convenience, the pixels of the display panel 50 will be referred to as first pixels and the pixels of the light emission device 10 will be referred to as second pixels. In addition, a plurality of first pixels corresponding to one second pixel will be referred to as a first pixel group.

In order to drive the light emission device 10, a signal control unit (not shown) for controlling the display panel 50 detects a highest gray value among the first pixels of the first pixel group, calculates a gray value required for the light emission of the second pixel according to the detected gray value, converts the calculated gray value into digital data, and generates a driving signal of the light emission device 10 using the digital data. The driving signal of the light emission device 10 includes a scan driving signal and a data driving signal.

Printed circuit boards (not shown), that is a scan printed circuit board and a data printed circuit board of the light emission device 10 are connected to drive IC packages 461 and 481, respectively. In order to drive the light emission device 10, the scan printed circuit board transmits a scan driving signal and the data printed circuit board transmits a data driving signal. Therefore, when an image is displayed by the first pixel group, the corresponding second pixel of the light emission device 10 is synchronized with the first pixel group to emit the light with a predetermined gray value.

As described above, the light emission intensities of the pixels of the light emission device 10 are independently controlled to emit a proper intensity of the light to each first pixel group of the display panel 50. As a result, the display device can enhance the dynamic contrast of the screen.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A light emission device comprising:
first and second substrates facing each other, each of the first and second substrates having an active area and an inactive area surrounding the active area;
an electron emission unit located on the active area of the first substrate; and
a light emission unit located on the active area of the second substrate and configured to provide light to a non-self emissive display device through the second substrate,
wherein the light emission unit includes a phosphor layer formed on the second substrate and an anode electrode formed on the phosphor layer, and wherein the area (A1) of the active area of the second substrate and the area (A2) of the phosphor layer satisfy the following relationship:
A₂/A₁≧about 0.80.

2. The light emission device of claim 1, wherein the area (A1) and the area (A2) satisfy the following relationship: A₂/A₁≦about 0.98.

3. The light emission device of claim 1, wherein the phosphor layer is formed only on the active area.

4. The light emission device of claim 1, further comprising a conductive layer located on the second substrate and formed of at least one of the following: Al, Mo, Cr and a conductive carbon-based material.

5. The light emission device of claim 1, wherein the active areas are configured to emit light, and wherein light is not emitted from the inactive areas.

6. A light emission device comprising:
first and second substrates facing each other, each of the first and second substrates having an active area and an inactive area surrounding the active area;
an electron emission unit located on the active area of the first substrate; and
a light emission unit located on the active area of the second substrate,
wherein the light emission unit includes a plurality of phosphor layers formed on the second substrate and spaced apart from each other, a conductive layer disposed between the phosphor layers, and an anode electrode formed on the phosphor layers and the conductive layer; and
wherein the area (A1) of the active area of the second substrate and the area (A3) of the conductive layer satisfy the following relationship:
about 0.02≦A3/A1≦about 0.20.

7. The light emission device of claim 6, wherein the area (A1) of the active area of the second substrate and the entire area (A2) of the phosphor layers satisfy the following relationship: A₂/A₁ about≦0.80.

8. A display device comprising:
a display panel for displaying an image; and
a light emission device for emitting light to the display panel,
wherein the light emission device comprises:
first and second substrates facing each other, each of the first and second substrates having an active area and an inactive area surrounding the active area; and
a light emission unit located on the active area of the second substrate,
wherein the light emission unit includes a phosphor layer formed on the second substrate and an anode electrode formed on the surface of the phosphor layer, and
wherein the area (A1) of the active area of the second substrate and the area (A2) of the phosphor layer satisfy the following relationship:
A₂/A₁≧about 0.80.

9. The display device of claim 8, wherein the light emission device includes a plurality of pixels, the number of which is less than that of the pixels of the display panel, arranged in first and second directions substantially crossing each other.

10. The display device of claim 9, further comprising an electron emission unit located on the active area of the first substrate and configured to emit electrons to the phosphor layer.

11. The display device of claim 9, wherein the phosphor layer includes a plurality of sections spaced apart from each other, and wherein each section corresponds to at least two pixels of the light emission device.

12. The display device of claim 8, further comprising a conductive layer, wherein the conductive layer is configured to transfer electrons remaining in the phosphor layer to the inactive area.

13. The display device of claim 10, wherein the electron emission unit comprises:
a plurality of first electrodes formed on the first substrate and extending in a first direction;
a plurality of second electrodes formed on the first substrate and extending in a second direction crossing the first direction, the second electrodes being insulated from the first electrodes; and
a plurality of electron emission regions electrically connected to one of the first electrodes and the second electrodes.

14. The display device of claim 12, wherein the conductive layer is configured to absorb at least a portion of light reflected from or transmitted through the display panel.

15. The display device of claim 12, wherein the area (A1) of the active area of the second substrate and the area (A3) of the conductive layer satisfy the following relationship:
A3/A1≧about 0.02.

16. The display device of claim 15, wherein the conductive layer is formed of a conductive carbon-based material or a metal including at least one of the following: Al, Mo and Cr.

17. The display device of claim 15, wherein the area (A1) of the active area of the second substrate and the area (A3) of the conductive layer satisfy the following relationship: A3/A1≦about 0.20.

18. The display device of claim 8, wherein the display panel is a liquid crystal display panel.
